(19) United States
(12) Patent Application Publication
(10) Pub. No.: US 2010/0284642 A1
(43) Pub. Date: Nov. 11, 2010

(54) BEARING WITH RESIN PULLEY

(76) Inventors: Katsunori Mineno, Shizuoka (JP); Goro Nakao, Shizuoka (JP)

Correspondence Address: WENDEROTH, LIND & PONACK, L.L.P., 1030 15th Street, N.W.,, Suite 400 East, Washington, DC, 20005-1503, US

(21) Appl. No.: 12/811,226

(22) PCT Filed: Jan. 19, 2009
(86) PCT No.: PCT/JP2009/050636

§ 371 Date: Jun. 30, 2010

(30) Foreign Application Priority Data
Jan. 22, 2008 (JP) 2008-011712

(51) Int. Cl. F16C 33/58

(52) U.S. Cl. 384/569

(57) ABSTRACT

The object is to improve heat dissipation ability of a rolling bearing while preventing creeping of a resin pulley.

With two axially spaced apart circumferential grooves 13 formed in the radially outer surface of the outer race 12, the resin pulley 14 is integrally fixed to the outer race 12 by injection molding such that the end surfaces of the outer race 12 and both end portions of the radially outer surface of the outer race 12 are exposed. Since resin forming a boss portion 15 of the resin pulley 14 is engaged in the circumferential grooves 13, radially extending side walls of the circumferential grooves 13 contact radial surfaces of the resin pulley 14. This prevents creeping of the resin pulley 14. Since the exposed end surfaces and radially outer surface of the outer race 12 act as heat dissipation surfaces, it is possible to improve the ability to dissipate heat from the bearing.

### TECHNICAL FIELD

This invention relates to a bearing assembly with a resin pulley in which the resin pulley is integrally fixed to the outer periphery of the outer race of a rolling bearing.

### BACKGROUND ART

In many of conventional bearing assemblies in which a resin pulley is integrally fixed to the outer periphery of the outer race of a rolling bearing, the resin pulley is integrally fixed to the outer periphery of the outer ring such that the base portion of the resin pulley embraces both end surfaces of the outer race, thereby preventing axial shifting of the resin pulley (see e.g. Patent document 1).

With this type of bearing assemblies with a resin pulley, since the radially outer surface of the outer race and the radially outer portions of the end surfaces of the outer race are covered by the resin pulley, their heat dissipation ability is inferior compared to bearing assemblies with a metal pulley, so that the bearing temperature tends to increase. As a result, due to a difference in thermal expansion coefficient between metal and resin, the coupling strength between the outer race and the resin pulley tends to decreases, which could cause creeping of the resin pulley, i.e. rotation of the resin pulley relative to the outer race.

In order to solve this problem, it has been proposed to add a heat conductive material to resin forming the resin pulley, thereby increasing the heat conductivity of the resin pulley so that heat produced form the rolling bearing can be smoothly dissipated (see Patent document 2), to form a plurality of radially spaced apart circumferential protrusions on the sides of the resin pulley, thereby increasing the surface area of the sides of the resin pulley and increasing the heat dissipation ability (see Patent document 3), or to seal between the respective end surfaces of the inner and outer races of the bearing with a seal member comprising a metal core and a rubber member covering the metal core, with a portion of the rubber member removed to expose the metal core, thereby increasing the heat dissipation ability (see Patent document 4).
Patent document 1: JP Utility Model Publication 7-28259A
Patent document 2: JP Paten Publication 2001-220917A
Patent document 3: JP Patent Publication 2004-308840A
Patent document 4: JP Patent Publication 2005-273787A

### DISCLOSURE OF THE INVENTION

### Object of the Invention

With the bearing assembly with a resin pulley disclosed in Patent document 2, since a heat conductive material is added to the resin forming the resin pulley, the cost for the resin material is high, which pushes up the production cost of the entire bearing assembly.

With the bearing assembly with a resin pulley disclosed in Patent document 3, a coupling arm coupling the boss portion of the resin pulley with its radially outer portion extends the entire circumference. Heat produced from the bearing and conducted through the outer ring tends to be accumulated in the coupling arm of the resin pulley. Thus, the protrusions formed on the sides of the resin pulley alone cannot sufficiently dissipate heat.

With the bearing assembly with a resin pulley disclosed in Patent document 4, although heat produced from the bearing is dissipated through the exposed portion of the metal core, since this bearing assembly has no means for dissipate heat conducted to the resin pulley through the outer race, heat tends to be accumulated in the resin pulley, so that heat produced from the bearing cannot be sufficiently dissipated.

An object of the present invention is to increase the heat dissipation ability of the rolling bearing while preventing creeping of the resin pulley.

### Means to Achieve the Object

In order to achieve this object, the present invention provides a bearing assembly with a resin pulley comprising a rolling bearing having an outer race, and the resin pulley, the resin pulley being integrally fixed to an outer periphery of the outer race by injection molding, wherein a circumferential groove is formed in a radially outer surface of the outer race, wherein a portion of resin forming the resin pulley is embedded in the circumferential groove, and wherein the resin pulley is integrally fixed to the outer periphery of the outer race with both end surfaces of a radially inner portion of the resin pulley located axially inside of the respective end surfaces of the outer race.

With this arrangement, once the resin pulley is integrally fixed to the outer periphery of the outer race by injection molding, a portion of the resin forming the resin pulley is embedded in the circumferential groove formed in the radially outer surface of the outer race, so that the resin pulley contacts the side surfaces of the circumferential groove. In other words, the radial surfaces of the outer race and the resin pulley contact each other. This eliminates the necessity of integrally fixing the resin pulley so as to embrace both end surfaces of the outer ring in order to bring the radial surfaces of the resin pulley and the outer race into contact with each other.

Since the radial surfaces of the resin pulley and the outer race are in contact with each other, the resistance to creeping of the resin pulley improves, so that it is possible to prevent creeping of the resin pulley. This makes it possible to integrally fix the resin pulley to the outer periphery of the outer race with both end surfaces of a radially inner portion of the resin pulley located axially inside of the respective end surfaces of the outer race, thereby exposing the end surfaces of the outer race and both end portions of the radially outer surface of the outer race.

Thus, compared to the bearing assembly disclosed in Patent document 1, in which the radially outer surface of the outer race is covered by the resin pulley, the dissipation ability improves. Since the resin pulley is embedded in the circumferential groove, the resin pulley engages the circumferential groove, thereby preventing axial shifting of the resin pulley too.

The axial position of the resin pulley relative to the radially outer surface of the outer race is determined e.g. by the specifications of the resin pulley and the rolling bearing, and the load applied to the pulley from the belt. For example, the resin pulley may be integrally fixed to the outer periphery of the outer race with an axial center of its radially inner portion coincident with an axial center of the outer race.

With this arrangement, since the distances between the end surfaces of the resin pulley and the corresponding end surfaces of the outer race are equal to each other, the lengths of the exposed end portions of the radially outer surface of the outer race are also equal to each other. This makes it possible to uniformly dissipate heat produced in the axial central portion of the outer race, which tends to especially heat up due to frictional heat between the raceway of the outer race and the rolling elements of the rolling bearing, thereby minimizing strains of the resin pulley due to thermal expansion.

If greater resistance to creeping is necessary, a plurality of the circumferential grooves may be formed on the radially outer surface of the outer race so as to be axially spaced from each other. With this arrangement, it is possible to further increase the radial surface areas of the resin pulley and the outer race that are in contact with each other.

In a particular arrangement, two such circumferential grooves may be formed so as to be symmetrical with respect to an axial center of the radially outer surface of the outer race.

With this arrangement, radially inward tightening force from the resin pulley due to heat shrinkage during injection molding never directly acts on the portion of the radially outer surface of the outer race located radially outwardly of the raceway (axially central portion of the radially outer surface of the outer race). This minimizes radially inward shifting of the raceway of the outer race, thus preventing reduction in the accuracy of the bearing after injection molding.

The circumferential groove may have a triangular, arcuate, trapezoidal or any other sectional shape. The circumferential groove may also be a square groove having a rectangular section and comprising side walls and a bottom. With this arrangement, during operation of the bearing, the resin pulley is thermally expanded due to heat from the bearing and is pressed against the side walls of the respective circumferential grooves.

This pressing force from the resin pulley acts entirely on their side walls, thus producing large frictional resistance between the side walls of the circumferential grooves and the radial surfaces of the resin pulley that are in contact with the side walls of the circumferential grooves. This effectively prevents creeping of the resin pulley.

In order to achieve the above object, the present invention also provides a bearing assembly with a resin pulley comprising a rolling bearing having an outer race, and the resin pulley, the resin pulley being integrally fixed to an outer periphery of the outer race by injection molding, wherein a portion of the radially outer surface of the outer race extending over the entire circumference and having a predetermined width is knurled, forming a knurled groove, wherein a portion of resin forming the resin pulley is embedded in the knurled groove, and wherein the resin pulley is integrally fixed to the outer periphery of the outer race with both end surfaces of a radially inner portion of the resin pulley located axially inside of the respective end surfaces of the outer race.

With this arrangement, since the radially inner portion of the resin pulley is engaged in the knurled groove, the frictional resistance between the radially outer surface and the radially inner portion of the resin pulley increases. As a result, the resistance to creeping of the resin pulley is maintained. Thus, as in the arrangement in which the peripheral groove is formed on the radially outer surface of the outer race, it is possible to expose the end surfaces of the outer race and both end portions of the radially outer surface of the outer race.

### ADVANTAGES OF THE INVENTION

According to the present invention, with the peripheral groove formed on the radially outer surface of the outer race, or the radially outer surface of the outer race knurled, the resin pulley is integrally fixed to the outer race by injection molding such that the end surfaces of the outer race and both end portions of the radially outer surface of the outer race are exposed. Thus, it is possible to improve heat dissipation ability of the rolling bearing, thereby minimizing heat-up of the bearing, while preventing creeping of the resin pulley.

### BRIEF DESCRIPTION OF THE DRAWINGS

FIG. 1 is a vertical sectional view of a bearing assembly with a resin pulley according to a first embodiment.

FIG. 2 is a perspective view thereof.

FIG. 3 is a vertical sectional view of a bearing assembly with a resin pulley according to a second embodiment.

FIG. 4 is a perspective view thereof.

### DESCRIPTION OF THE REFERENCE NUMERALS

11. Rolling bearing
12. Outer race
13. Peripheral groove
14. Resin pulley
15. Boss portion
16. Radially outer portion
17. Knurled groove

### BEST MODE FOR EMBODYING THE INVENTION

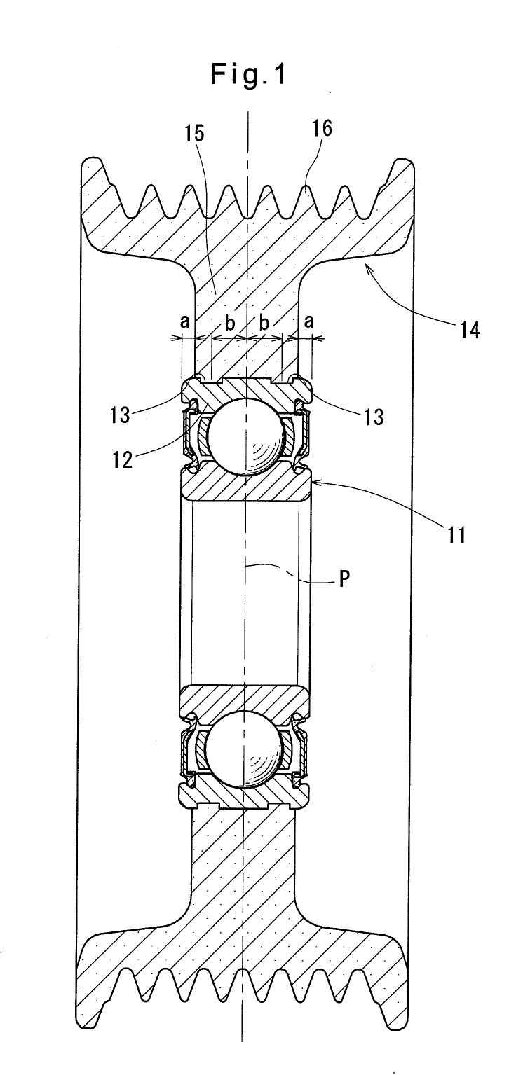

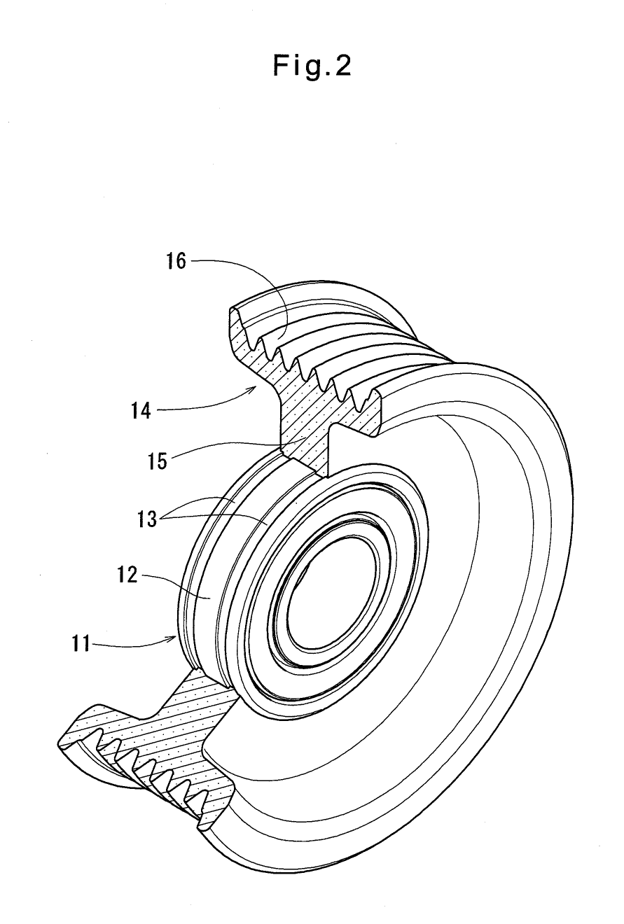

Now the embodiments are described with reference to the drawings. FIGS. 1 and 2 show the first embodiment. This bearing assembly with a resin pulley includes a rolling bearing 11 and a resin pulley 14 integrally formed on the outer race 12 of the bearing 11 by injection molding.

The rolling bearing 11 is a known rolling bearing, and may be e.g. a deep groove ball bearing, an angular ball bearing, a cylindrical roller bearing or a tapered roller bearing.

The outer race 12 is formed with two axially spaced circumferential grooves 13 in its radially outer surface. The circumferential grooves 13 are square grooves having a rectangular cross-section, and are symmetrically arranged with respect to the axial center of the outer race 12. In other words, the circumferential grooves 13 are spaced axially outwardly by equal distances b from a plane P passing the axial center of the outer race 12. The circumferential groove 13 are not limited to square grooves having a rectangular cross-section, but may be grooves having a triangular, arcuate or trapezoidal cross-section.

Since the circumferential grooves 13 are provided symmetrically with respect to the axial center of the outer race 12, tightening force from the resin pulley due to heat shrinkage during injection molding never directly acts on the portion of the radially outer surface of the outer race located radially outwardly of the raceway (axially central portion of the radially outer surface of the outer race 12). This minimizes radially inward shifting of the raceway of the outer race 12, thus minimizing influence on the accuracy of the bearing.

As shown in FIG. 2, the resin pulley 14 comprises a radially inner boss portion 15 and a radially outer peripheral portion 16 which is integral with the boss portion 15 and around which a belt (not shown) is trained. The boss portion 15 is narrower in axial width than the radially outer surface of the outer race 12. The peripheral portion 16 has pulley grooves in its outer end.

The resin pulley 14 is integrally fixed to the outer periphery of the outer race 12, with both end surfaces of the boss portion 15 located inside of the respective end surfaces of the outer race 12 and with the axial center of the boss portion 15 coincident with the axial center of the outer race 12. Thus, both end surfaces of the outer race 12 and both end portions of the radially outer surface of the outer race 12 are exposed, with the exposed end portions of the outer race 12 having the same width a (see FIG. 1). This arrangement makes it possible to uniformly dissipate heat produced in the axial central portion of the outer race 12, which tends to especially heat up due to frictional heat between the raceway of the outer race 12 and the rolling elements of the rolling bearing, thereby minimizing strains of the resin pulley 14 due to thermal expansion.

Portions of the resin forming the resin pulley 14 are embedded in the respective circumferential grooves 13. During operation of the bearing, the resin pulley 14 is thermally expanded due to heat from the bearing and is pressed against the side walls of the respective circumferential grooves 13. Since the circumferential grooves 13 are square grooves having a rectangular cross-section, the pressing force from the resin pulley 14 acts entirely on their side walls, thus producing large frictional resistance between the side walls of the circumferential grooves 13 and the radial surfaces of the resin pulley 14 that are in contact with the side walls of the circumferential grooves 13. This effectively prevents creeping of the resin pulley 14.

With this arrangement, since frictional resistance is produced between the radial contact surfaces, it is not necessary to integrally fixing the boss portion 15 of the resin pulley 14 to the outer race 12 so as to embrace the outer race 12 from outside. Thus, it is possible to expose both end surfaces of the outer race 12 and both end portions of the radially outer surface of the outer race 12. This improves heat dissipation ability of the bearing compared to a conventional bearing of which the radially outer surface of the outer race 12 is covered by the resin pulley, such as the one disclosed in Patent document 1.

According to the radial load applied to the resin pulley 14 from the belt, more than two axially spaced circumferential grooves 13 or only one circumferential groove 13 may be formed on the radially outer surface of the outer race 12. For example, if the axial load applied to the resin pulley 14 from the belt is relatively small, only one circumferential groove 13 may be formed on the radially outer surface of the outer race 12. If an odd number (except one) of the circumferential grooves 13 are formed on the radially outer surface of the outer race 12, one of them is formed at the axial center and the remaining circumferential grooves symmetrically with respect to the plane P passing the axial center, provided this arrangement does not affect the accuracy of the bearing or the strength of the outer race 12.

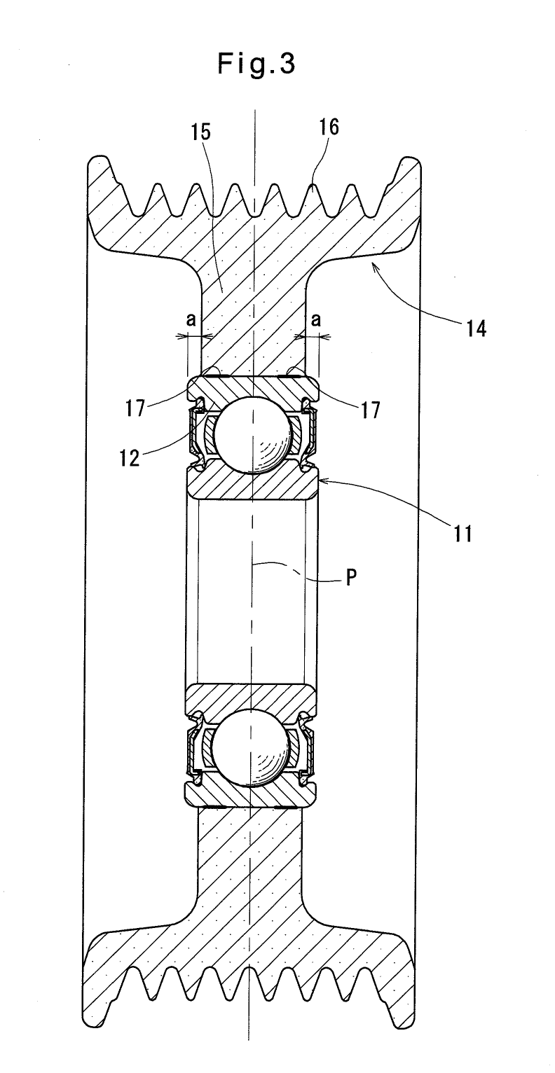

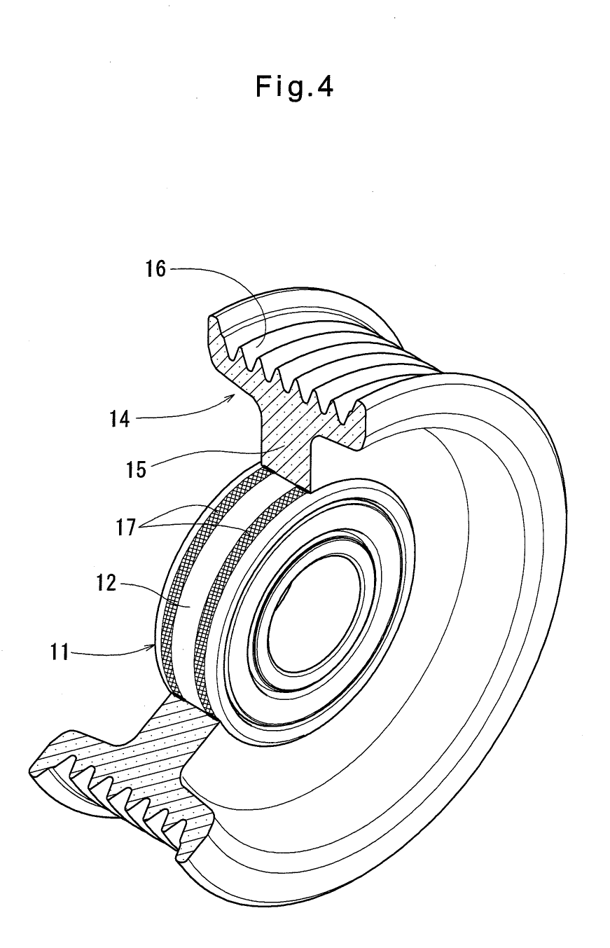

FIGS. 3 and 4 show the second embodiment. The bearing assembly with a resin pulley of this embodiment is the same as the first embodiment in that the resin pulley 14 is integrally fixed to the outer periphery of the outer race 12 by injection molding, with both end surfaces of the boss portion 15 of the resin pulley 14 located inside the respective end surfaces of the outer race 12, but differs from the first embodiment in that portions of the radially outer surface of the outer race 12 extending over the entire circumference and having a predetermined axial width are knurled. Otherwise, this embodiment is the same as the first embodiment. Thus, elements corresponding to those of the first embodiment are denoted by identical numerals.

In other words, in the second embodiment, as means for preventing creeping of the resin pulley 14, portions of the radially outer surface of the outer race 12 having a predetermined axial width are knurled instead of forming the circumferential grooves 13 thereon (see FIGS. 3 and 4). Resin forming the boss portion 15 of the resin pulley is engaged in the knurled grooves 17 formed by knurling, thereby increasing the frictional resistance between the resin pulley 14 and the radially outer surface of the outer race 12. The axial width of the knurled grooves formed by knurling is determined by experiments and/or actual operation of the bearing according to the load applied to the resin pulley 14 from the belt.

By this frictional resistance, the resistance to creeping of the resin pulley 14 is maintained, which in turn makes it possible to expose the both end surfaces of the outer race 12 and both end portions of the radially outer surface of the outer race 12. As a result, heat dissipation ability of the bearing improves compared to bearings of which the radially outer surface of the outer race 12 is covered by the resin pulley 14 as disclosed in Patent document 1.

1. A bearing assembly with a resin pulley comprising a rolling bearing having an outer race, and the resin pulley, said resin pulley being integrally fixed to an outer periphery of the outer race by injection molding,
characterized in that a circumferential groove is formed in a radially outer surface of the outer race, that a portion of resin forming the resin pulley is embedded in the circumferential groove, and that the resin pulley is integrally fixed to the outer periphery of the outer race with both end surfaces of a radially inner portion of the resin pulley located axially inside of the respective end surfaces of the outer race.

2. The bearing assembly of claim 1 characterized in that the resin pulley is integrally fixed to the outer periphery of the outer race with an axial center of its radially inner portion coincident with an axial center of the outer race.

3. The bearing assembly of claim 1 characterized in that there are provided a plurality of the circumferential grooves so as to be axially spaced from each other.

4. The bearing assembly of claim 3 characterized in that there are provided two of the circumferential grooves that are symmetrically arranged with respect to an axial center of the radially outer surface of the outer race.

5. The bearing assembly of claim 1 characterized in that the circumferential groove or each of the circumferential grooves is a square groove having a rectangular section.

6. A bearing assembly with a resin pulley comprising a rolling bearing having an outer race, and the resin pulley, said resin pulley being integrally fixed to an outer periphery of the outer race by injection molding,
characterized in that a portion of the radially outer surface of the outer race extending over the entire circumference and having a predetermined width is knurled, forming a knurled groove, that a portion of resin forming the resin pulley is embedded in the knurled groove, and that the resin pulley is integrally fixed to the outer periphery of the outer race with both end surfaces of a radially inner portion of the resin pulley located axially inside of the respective end surfaces of the outer race.

7. The bearing assembly of claim 2 characterized in that there are provided a plurality of the circumferential grooves so as to be axially spaced from each other.

8. The bearing assembly of claim 2 characterized in that the circumferential groove or each of the circumferential grooves is a square groove having a rectangular section.

9. The bearing assembly of claim 3 characterized in that the circumferential groove or each of the circumferential grooves is a square groove having a rectangular section.

10. The bearing assembly of claim 4 characterized in that the circumferential groove or each of the circumferential grooves is a square groove having a rectangular section.
